(19) United States
(12) Patent Application Publication
(10) Pub. No.: US 2015/0016277 A1
(43) Pub. Date: Jan. 15, 2015

(54) INTERCONNECT ERROR NOTIFICATION SYSTEM

(71) Applicant: Dell Products L.P., Round Rock, TX (US)

(72) Inventors: Hana Schuster Smith, Austin, TX (US); Jason Garth Pearce, Round Rock, TX (US)

(21) Appl. No.: 13/938,949

(22) Filed: Jul. 10, 2013

(51) Int. Cl. H04L 12/24; H04L 12/26

(52) U.S. Cl. CPC H04L 41/0686; H04L 43/0823
USPC 370/244

(57) ABSTRACT

A IHS network includes a first switch having first switch ports and a respective visual port indicator associated with each of the first switch ports. A second switch having second switch ports is included in the IHS network, and at least one interconnect connects one of the second switch ports to one of the first switch ports on the first switch. A fabric manager is coupled to the IHS network and operable to communicate with the first switch and the second switch to determine that one of the first switch ports on the first switch is that associated with a fabric interconnect error. The fabric manager then communicates with the first switch to cause the respective visual first switch port indicator that is associated with the one of the first switch ports that is associated with the fabric interconnect error to visually indicate the fabric interconnect error.

### BACKGROUND

The present disclosure relates generally to information handling systems, and more particularly to notifying a user of interconnect errors with regard to interconnecting information handling systems (e.g., in a meshed Ethernet fabric.)

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

In some IHS architectures such as, for example, distributed core architectures, a plurality of switch IHSs are connected together such that, for example, the plurality of switch IHSs act as a single entity or switching fabric. Prior to deploying the switching fabric, a user or administrator must connect the switch interlinks using a plurality of wiring/cabling diagrams. Because each switch in the fabric is assigned a unique function or role, a unique wiring/cabling diagram is generated for each switch to reflect that function or role. As the fabric becomes larger (e.g., conventional systems can include 128 switches) and more complicated (e.g., incorporating chassis switches, rack switches, stacked switches, etc.), the number of interlinks and the wiring/cabling complexity increases, which can result in wiring/cabling errors. In conventional systems, when the fabric is deployed, the success and/or failure of the fabric deployment is determined. In response to that determination, a wiring/cabling error list may be provided to the user or administrator that includes details about, for example, missing interlink connections or wiring mismatches. To correct the wiring/cabling errors, the user or administrator must then find the switches that are associated with the wiring/cabling errors, find the ports on those switches that are associated with the wiring/cabling errors, and then cross-reference the wiring/cabling error list with the wiring/cabling diagrams for each switch that includes a port included in the wiring/cabling error list and attempt to correct the wiring/cabling error. Such conventional processes are time-consuming, error-prone, and inefficient.

Accordingly, it would be desirable to provide an improved interconnect error notification system.

### SUMMARY

According to one embodiment, an interconnect error notification system includes a processor; and a non-transitory memory coupled to the processor and including instructions that, when executed by the processor, cause the processor to provide a fabric manager that is operable to: communicate with a first switch that is part of a fabric that includes a second switch, wherein the first switch include a plurality of ports that are each associated with a respective visual port indicator located on the first switch, and at least one of the plurality of ports on the first switch is connected by an interconnect to the second switch; determine that a fabric interconnect error is associated with a first port of the plurality of ports on the first switch; and communicate with the first switch to cause the respective visual port indicator that is associated with the first port and that is located on the first switch to visually indicate the fabric interconnect error.

### BRIEF DESCRIPTION OF THE DRAWINGS

FIG. 1 is a schematic view illustrating an embodiment of an information handling system.

FIG. 2 is a schematic view illustrating an embodiment of networked system.

FIG. 3 is a schematic view illustrating an embodiment of a meshed Ethernet fabric in the networked system of FIG. 2.

FIG. 4a is a front view of an embodiment of a switch IHS including a plurality or ports and respective visual port indicators.

FIG. 4b is a schematic view of an embodiment of the switch IHS of FIG. 4a.

FIG. 5a is a flow chart illustrating an embodiment of a method for interconnect error notification.

FIG. 5b is a screen shot illustrating an embodiment of a graphical interconnect plan.

FIG. 5c is a screen shot illustrating an embodiment of a tabular interconnect plan.

FIG. 5d is a screen shot illustrating an embodiment of a missing link interconnect error table.

FIG. 5e is a screen shot illustrating an embodiment of a wiring mismatch interconnect error table.

FIG. 5f is a screen shot illustrating an embodiment of a graphical interconnect error screen.

FIG. 5g is a front view illustrating an embodiment of visual port indicators on a pair of switches providing visual indications of fabric interconnect errors.

FIG. 5h is a front view illustrating an embodiment of the visual port indicators on the pair of switches of FIG. 5g following correction of the fabric interconnect errors.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a display device or monitor, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

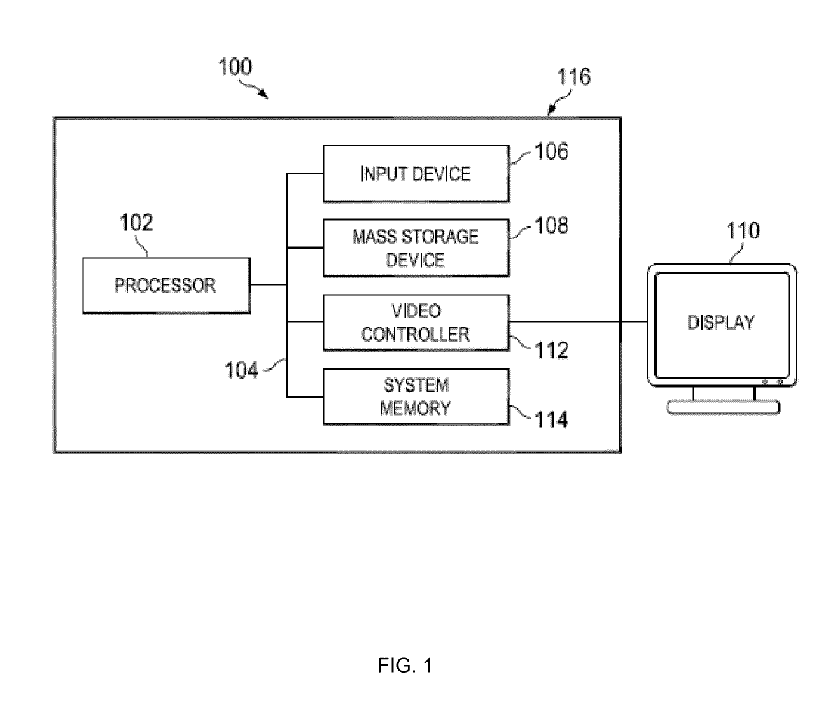

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

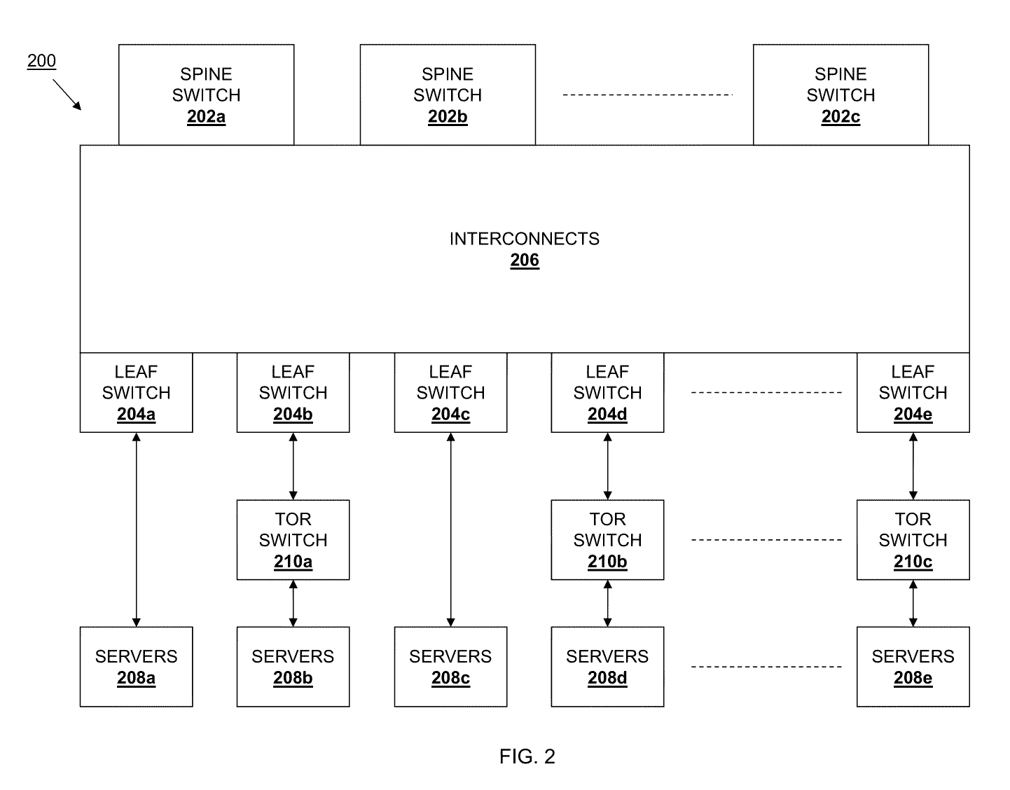

Referring now to FIG. 2, an embodiment of a networked system 200 is illustrated. The networked IHS system 200 includes a meshed Ethernet fabric such as, for example, a distributed core architecture that may be used to replace a convention core architecture, as described in the Dell Fabric Manager Deployment Guide 1.0.0 (“Dell Fabric Manager Deployment Guide”), available at www.dell.com at http://i.dell.com/sites/doccontent/shared-content/data-sheets/en/Documents/DFM_Deployment_{—}1_{—}0_{—}0_{—}1.pdf, the disclosure of which is incorporated by reference. As discussed in the Dell Fabric Manager Deployment Guide, a conventional core architecture may be replaced with a distributed core architecture that includes a plurality of switches that are interconnected to provide a scalable, high-performance network that replaces traditional and aggregation layers in the conventional core architecture.

The networked system 200 includes a plurality of interconnected switch IHSs, any of which may include some or all of the components of the IHS 100 discussed above with reference to FIG. 1. In the illustrated embodiment, a plurality of spine switch IHSs 202a, 202b, and 202c are coupled to a plurality of leaf switch IHSs 204a, 204b, 204c, 204d, and 204e by a plurality of interconnects 206. While only three spine switch IHSs are illustrated interconnected with five leaf switch IHSs for clarity of illustration and discussion, the networked system 200 may be scaled, based on user need, to include any number of spine switch IHSs and leaf switch IHSs. For example, the Dell Fabric Manager Deployment Guide discusses distributed core architectures that include up to sixteen spine switch IHSs and thirty-two leaf switch IHSs, and future deployments are envisioned as including 128 or more total switch IHSs The leaf switch IHSs may be coupled directly to server IHSs (e.g., as illustrated with leaf switch IHSs 204a and 204c directly connected to server IHSs 208a and 208c, respectively), or may be coupled to server IHSs through Top-of-Rack (ToR) switch IHSs (e.g., as illustrated with leaf switch IHSs 204b, 204d, and 204e connected to server IHSs 208b, 208d, and 208e, respectively, through ToR switch IHSs 210a, 210b, and 210c, respectively.) Any of the server IHSs 208a-208e and the ToR switch IHSs 210a-210c may include some or all of the components of the IHS 100 discussed above with reference to FIG. 1.

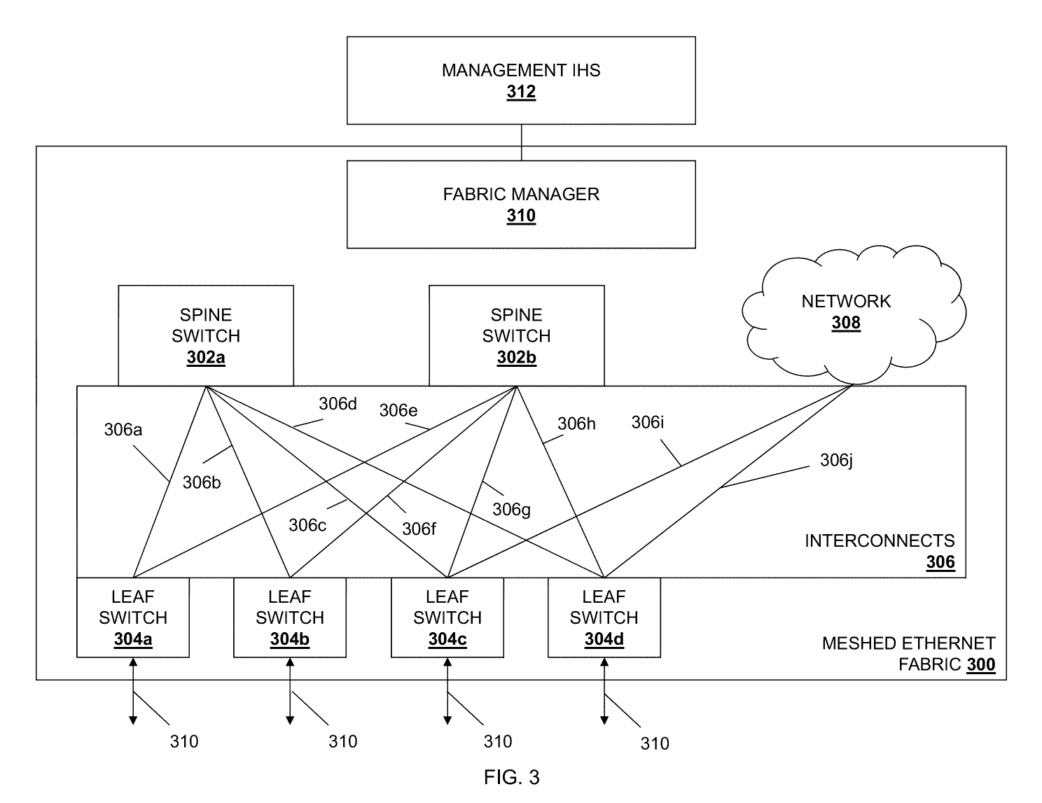

Referring now to FIG. 3, an embodiment of a meshed Ethernet fabric 300 is illustrated. In an embodiment, the meshed Ethernet fabric 300 may be the distributed core architecture discussed above with reference to FIG. 2 that includes the spine switch IHSs 202a-202c connected to the leaf switch IHSs 204a-204e through interconnects 206. The meshed Ethernet fabric 300 includes spine switch IHSs 302a and 302b (which may correspond to any of the spine switch IHSs 202a-202c of FIG. 2) and leaf switch IHSs 304a, 304b, 304c, and 304d (which may correspond to any of the leaf switch IHSs 204a-204c of FIG. 2), with each spine switch IHS 302a and 302b connected to each leaf switch IHS 304a-304d by interconnects 306. For example, in the illustrated embodiment, the spine switch IHS 302a is connected to the leaf switch IHS 304a by interconnect 306a, to the leaf switch IHS 304b by interconnect 306b, to the leaf switch IHS 304c by interconnect 306c, and to the leaf switch IHS 304d by interconnect 306d; and the spine switch IHS 302b is connected to the leaf switch IHS 304a by interconnect 306e, to the leaf switch IHS 304b by interconnect 306f, to the leaf switch IHS 304c by interconnect 306g, and to the leaf switch IHS 304d by interconnect 306h. In an embodiment, each spine switch IHS 302a and 302b and each leaf switch IHS 304a-304d includes a plurality of ports, discussed in further detailed below, and the interconnects 306a-306h each include an interconnect cable with connectors that, for a given pair of switch IHSs, include a first connector on the interconnect cable engaging a port on a first switch IHS and a second connector on the interconnect cable engaging a port on the second switch IHS. A network 308 such as, for example, a Wide Area Network (WAN) is coupled to some or all of the leaf switch IHSs by interconnects 306. For example, in the illustrated embodiment, the network 308 is coupled to the leaf switch IHS 304c by interconnect 306i, and to the leaf switch IHS 304d by interconnect 306j. Each leaf switch IHS 304a-304d provides one or more downlinks and/or uplinks 310 through its ports to connected devices (e.g., the server IHSs 208a and 208c, the ToR switch IHSs 210a-210c), and/or other connected devices. In an embodiment, a 10 gigabit Ethernet (GbE) downlink virtual local area network (VLAN) and virtual router redundancy protocol (VRRP) may be utilized over the downlinks and/or uplinks 310.

A fabric manager 310 is coupled to each of the spine switch IHSs 302a and 302b and the leaf switch IHSs 304a-304d, as well as to a management IHS 312 (which may include some or all of the components of the IHS 100 discussed above with reference to FIG. 1.) The fabric manager may be provided on any IHS as instructions in a non-transitory memory in the IHS (e.g., the system memory 114 or mass storage device 108 in the IHS 100) that, when executed by a processor in the IHS (e.g., the processor 102 in the IHS 100), cause the processor to provide the fabric manager 310 with the functionality described herein. In the illustrated embodiment, a fabric manager 310 is included in the meshed Ethernet fabric 300. However, in other embodiments, the fabric manager 310 may be located on a server IHS that is coupled to the meshed Ethernet fabric 300, either directly or over a network. In an embodiment, the fabric manager 310 views the meshed Ethernet fabric 300 as a single, logical switch.

In the meshed Ethernet fabric 300, the spine switch IHSs 302a and 302b connect the leaf switch IHSs 304a-304d together using a routing protocol. For example, the interconnects 306 may provide a 40 gigabit Ethernet (GbE) interconnect using the Open Shortest Path First (OSPF) link-state routing protocol. The leaf switch IHSs 304a-304d may include ports that connect to the spine switch IHSs 302a and 302b, server IHSs (e.g., the server IHSs 208a and 208c), ToR switch IHSs (e.g., the ToR switch IHSs 210a-210c), other devices, and the network 308. The spine switch IHSs 302a and 302b are operable to move data traffic between the leaf switch IHSs 304a-304d bi-directionally, providing redundancy and load-balancing. The meshed Ethernet fabric allows data traffic to move efficiently at a higher bandwidth with lower latencies relative to conventional core architectures, as there is no single point of failure that can disrupt the entire meshed Ethernet fabric.

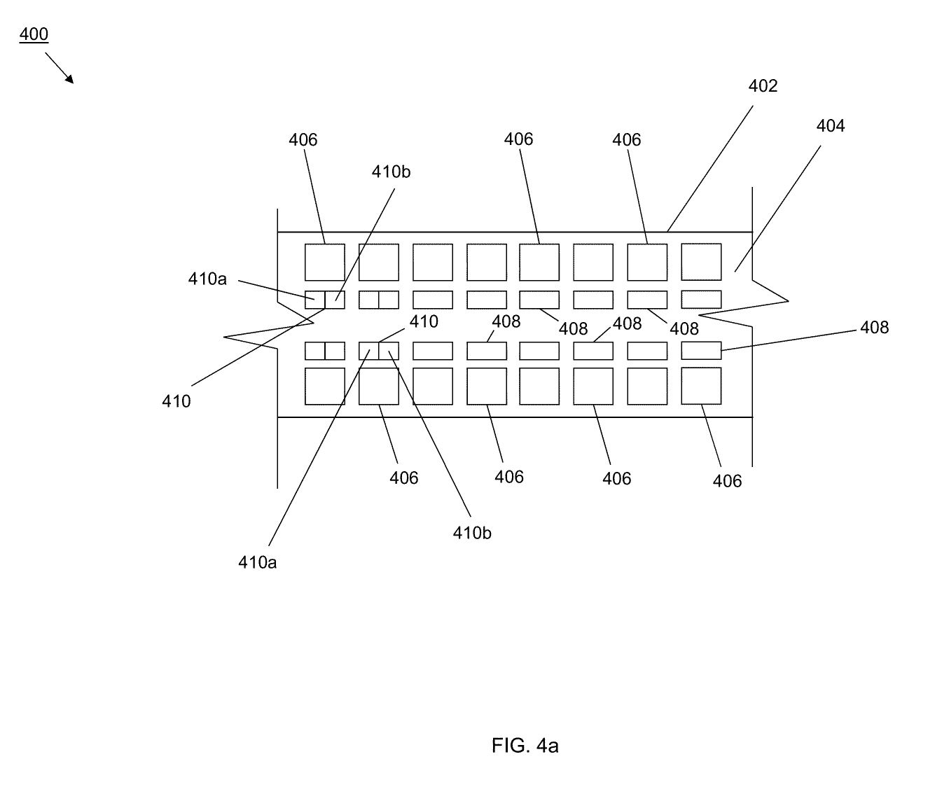

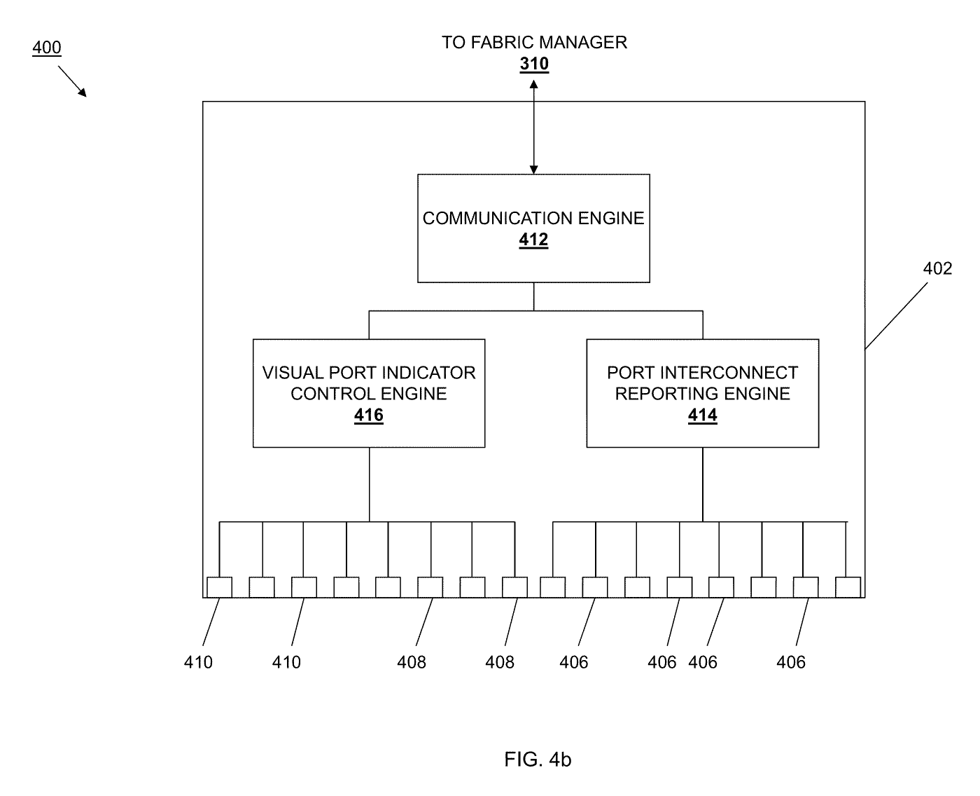

Referring now to FIGS. 4a and 4b, an embodiment of a switch IHS 400, which may be any of the spine switch IHSs and/or leaf switch IHSs discussed above, is illustrated. The switch IHS 400 includes a switch chassis 402 having an outer surface 404. A plurality of ports 406 are provided on the outer surface 402 and, as discussed above, each port 406 may be configured to couple with a connector on an interconnect cable (e.g., the interconnects 306a-306j in FIG. 3). A visual port indicator is associated with each port 406. In the illustrated embodiment, visual port indicators associated with respective ports 406 are located immediately above or below their respective port 406. The visual port indicators in the illustrated embodiment include single color visual port indicators 408 and multi-color visual port indicators 410. For example, visual port indicator may include light emitting devices (LEDs), with the single color visual port indicators 408 including an LED or LEDs operable to emit a single color (e.g., green), and with the multi-color visual port indicators including a status portion 410a and an activity portion 410b and an LED or LEDs that are operable to emit multiple colors (e.g., green for the status portion 410a and amber for the activity portion 410b.) While the switch IHS 400 has been illustrated as including both single color visual port indicators 408 and multi-color visual port indicators 410, one of skill in the art will recognize that some switch IHSs may only include single color visual port indicators 408 and some switch IHSs may only include multi-color visual port indicators 410.

In an embodiment, the switch IHS 400 includes a non-transitory memory in the switch chassis 402 (e.g., the system memory 114 or mass storage device 108 in the IHS 100) that, when executed by a processor in the switch chassis 402 (e.g., the processor 102 in the IHS 100), cause the processor to provide a communication engine 412, a port cabling reporting engine 414, and a visual port indicator control engine 416 with the functionality described herein. In an embodiment, the communication engine 412 is coupled to the fabric manager 310 (e.g., through a connection between the server IHS including the fabric manager 310 and the switch IHS 400) and each of the port interconnect reporting engine 414 and the visual port indicator control engine 416, the port interconnect reporting engine 414 is coupled to each of the ports 406 on the switch IHS 400, and the visual port indicator control engine 416 is coupled to each of the visual port indicators (e.g., the single color visual port indicators 408 and the multi-color visual port indicators 410.) In an embodiment, the communication engine 412 is operable to send and receive communications between any or all of the fabric manager 310, the port interconnect reporting engine 414, and the visual port indicator control engine 416. In an embodiment, the port interconnect reporting engine 414 is operable to determine and communicate the current interconnect status of any of the ports 406. In an embodiment, the visual port indicator control engine 416 is operable to control the visual indications provided by any of the visual port indicators (e.g., the single color visual port indicators 408 and the multi-color visual port indicators 410.)

In an embodiment, the visual port indicator control engine 416 in the switch IHS 400 may include low-level diagnostic controls that provide for direct control of the visual port indicators 408 or 410 (e.g., direct control of the state of the LED(s) included in the visual port indicators). For example, such low-level diagnostic controls may conventionally be used to test the functionality of various LEDs or other visual indicators on the switch IHS 400 during manufacture and/or before shipping to a user. In another embodiment, the visual port indicator control engine 416 in the switch IHS 400 may not include the low-level diagnostic controls discussed above, and instead by be operable to control each visual port indicator 408 and 410 based on the data traffic received by their associated port 406.

Each of the spine switch IHSs 302a and 302b and the leaf switch IHSs 304a-304d in the meshed Ethernet fabric 300 of FIG. 3 are assigned a unique function and/or role in the meshed Ethernet fabric 300. To enable the performance of those functions and/or roles, prior to deploying the meshed Ethernet fabric 300 of FIG. 3, a user or administrator must connect the interconnects 306a-306h between specific ports on each of the spine switch IHSs 302a and 302b and the leaf switch IHSs 304a-304d. This requires a unique interconnect diagram for each of the spine switch IHSs 302a and 302b and the leaf switch IHSs 304a-304d that the user or administrator uses to interconnect the meshed Ethernet fabric 300. As the meshed Ethernet fabric 300 becomes large and more complicated, the number of interconnects 306 and the interconnect complexity increases, which can result in interconnect errors. In conventional systems, when the meshed Ethernet fabric 300 is deployed with interconnect errors (e.g., missing interconnects at ports, interconnects connected to the wrong ports, etc.), an interconnect error list is provided to the user or administrator that includes details about those interconnect errors. To correct the interconnect errors, the user or administrator must find the switch IHSs that are associated with the interconnect errors, find the ports on those switches that are associated with the interconnect errors, and then cross-reference the interconnect error list with the unique interconnect diagrams for each of the spine switch IHSs 302a and 302b and the leaf switch IHSs 304a-304d so that the user or administrator can correct the interconnect errors. Thus, a user or administrator may spend hours in a datacenter providing interconnects between spine switch IHSs and leaf switch IHSs and then connecting the leaf switch IHSs to ToR switch IHSs and/or server IHSs, and then travel to a remote management location to deploy the network. If interconnect errors exist, the user may then receive the interconnect error list, and must travel back to the datacenter with the interconnect error list and hundreds of pages of unique interconnect diagrams, and cross reference those to attempt to find the switches and their ports that are associated with the interconnect errors and attempt to correct those interconnect errors.

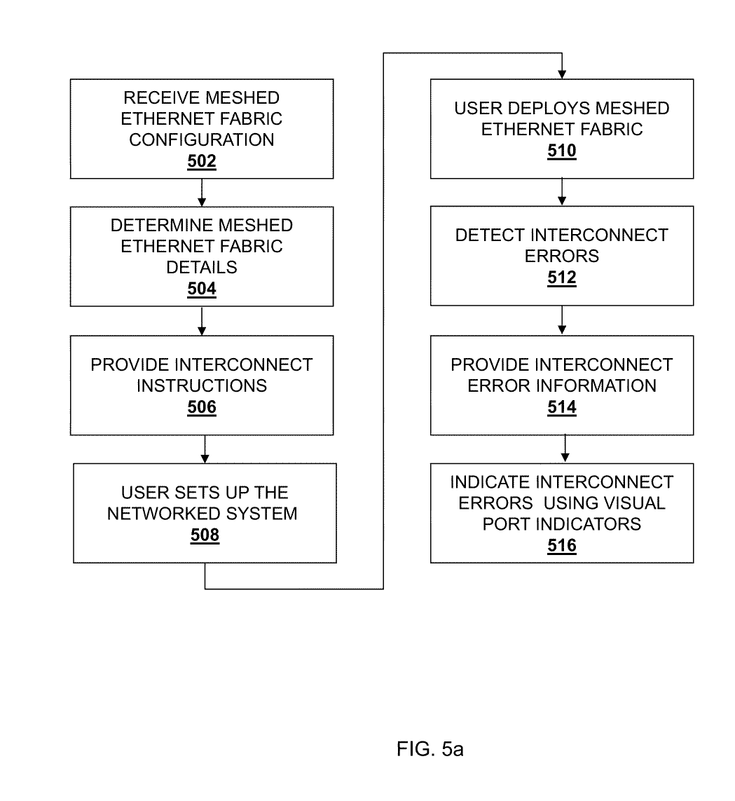

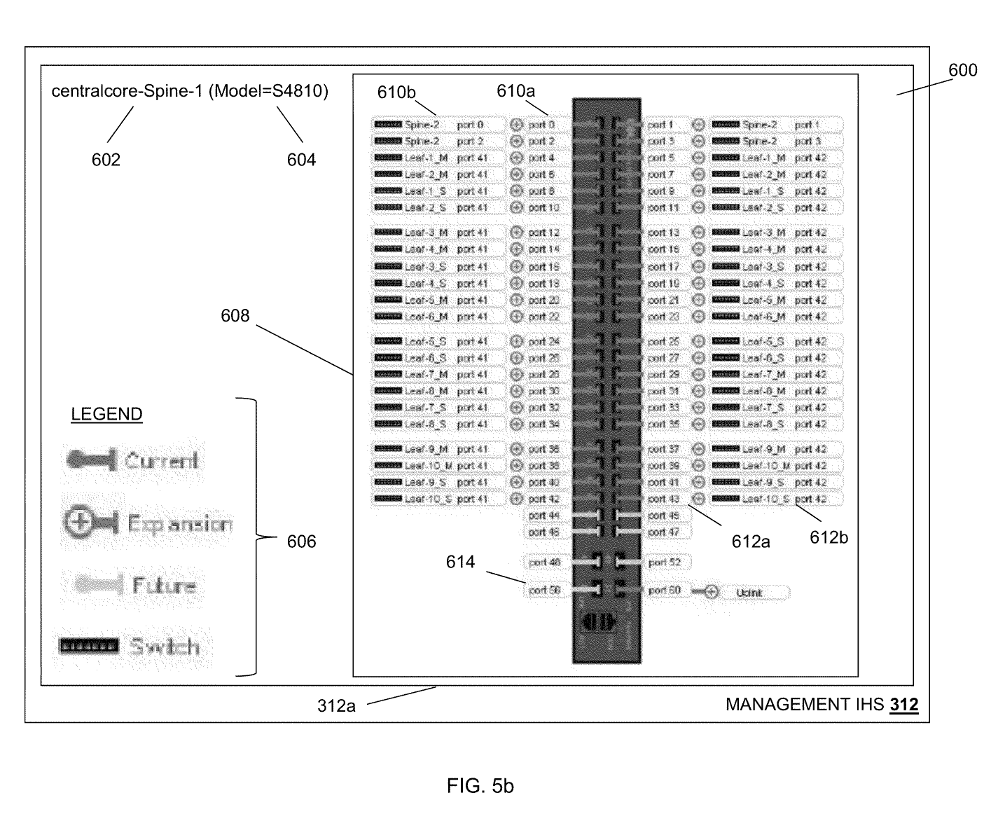

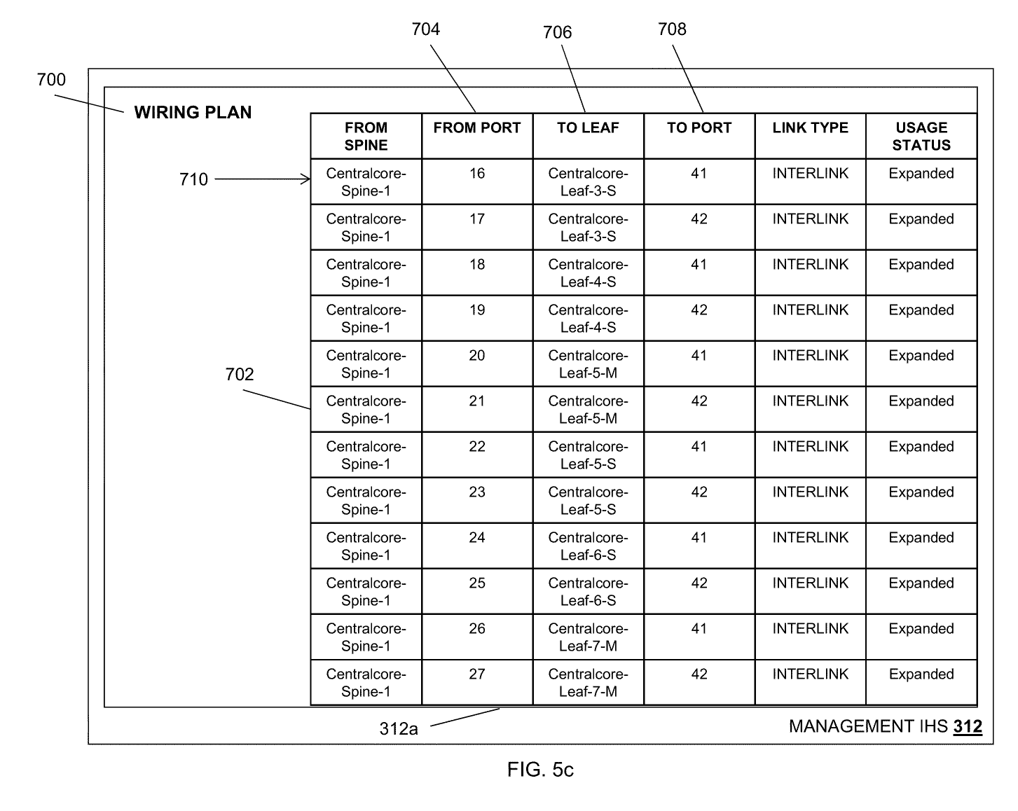

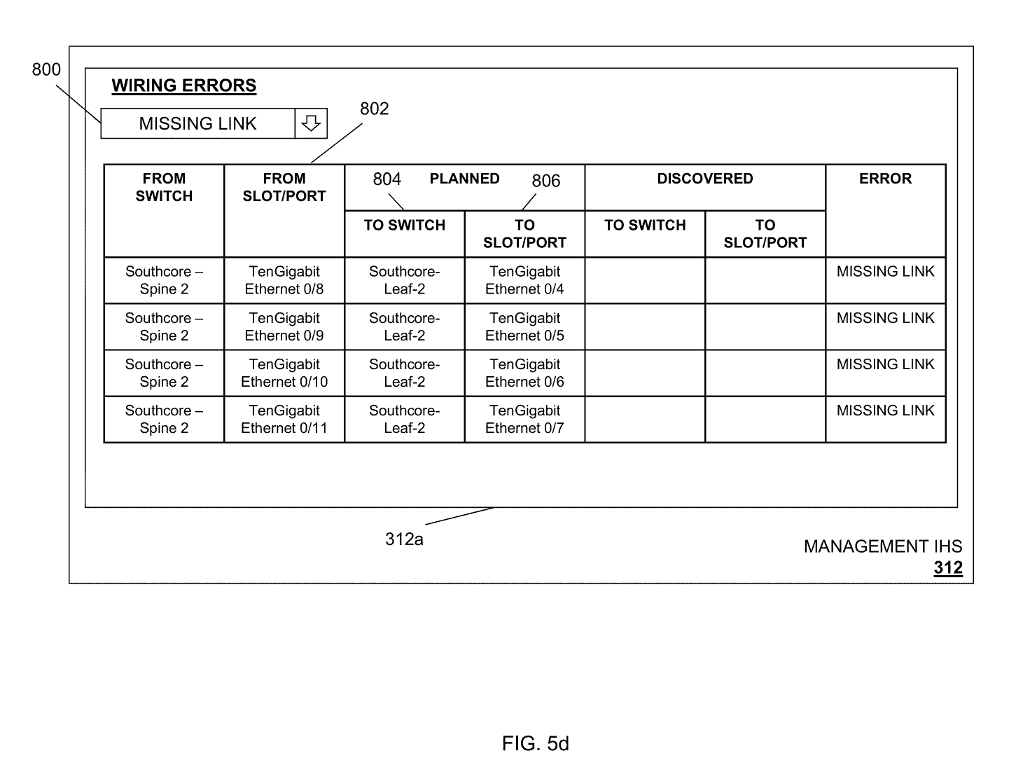

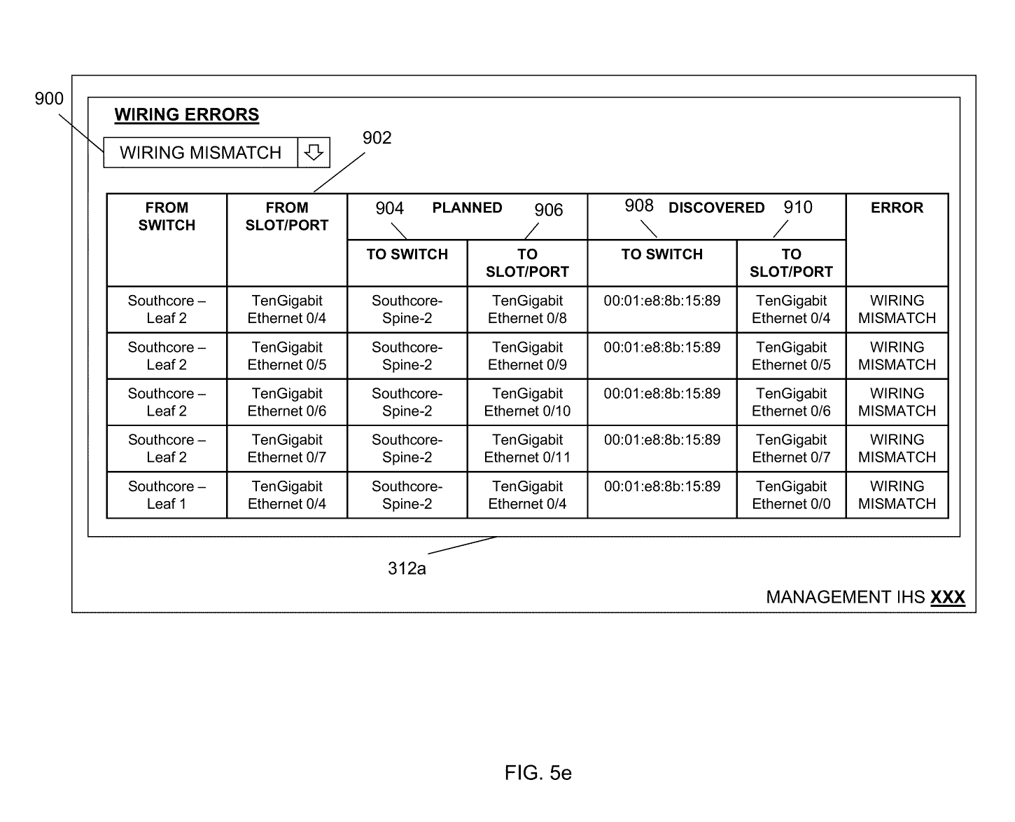

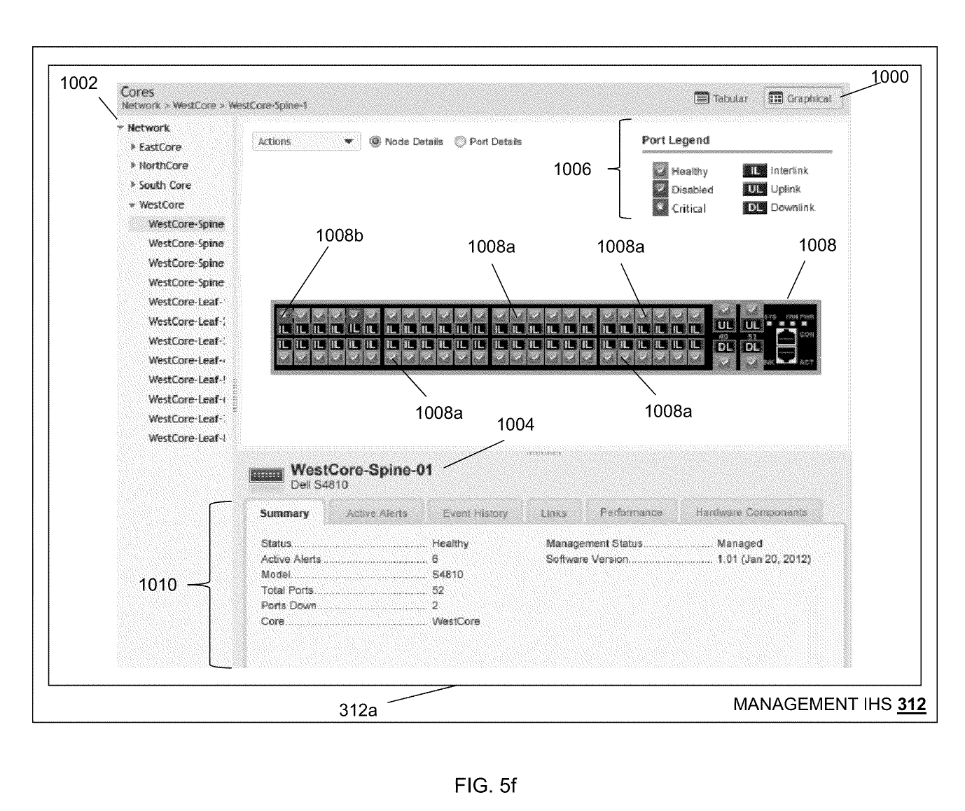

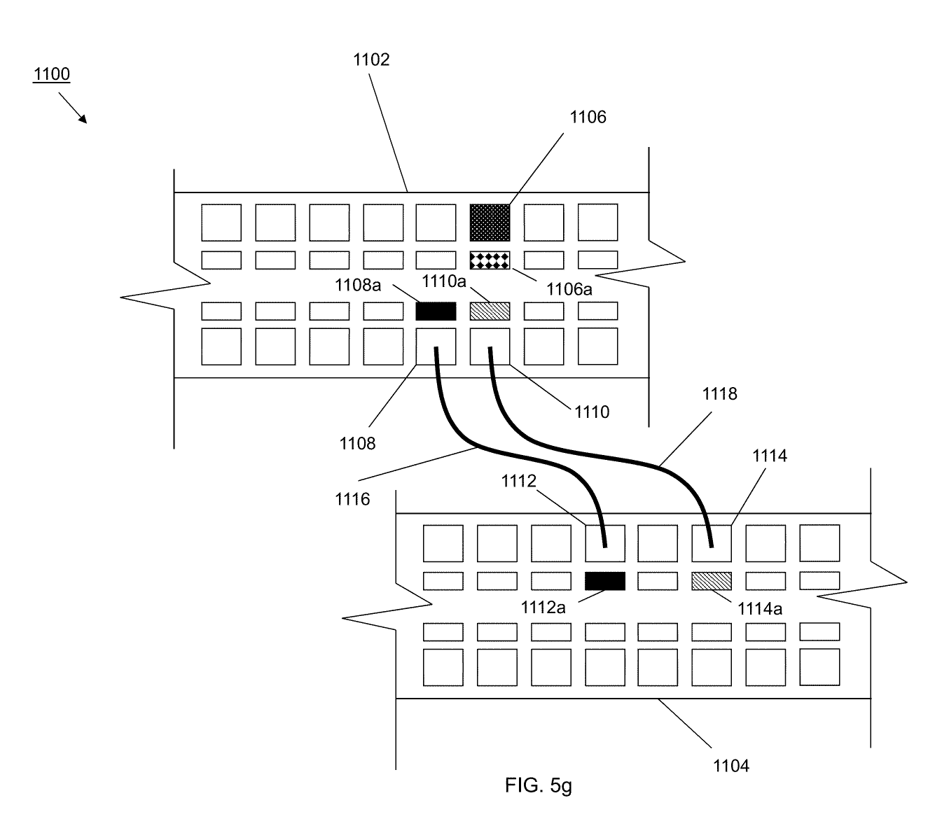

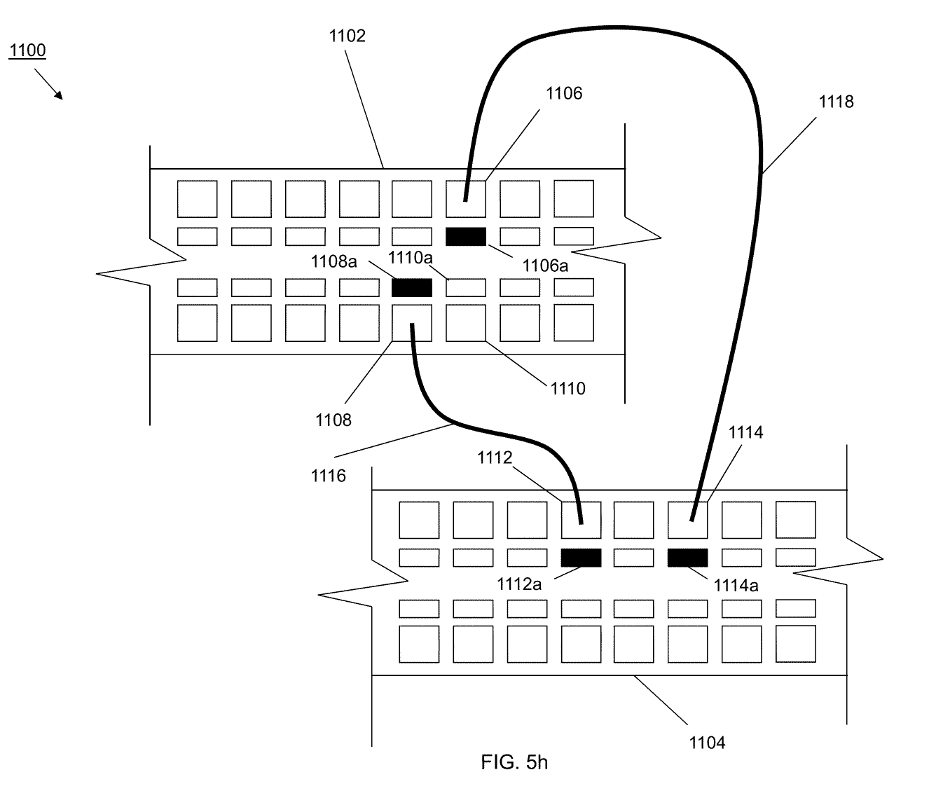

Referring now to FIGS. 5a, 5b, 5c, 5d, 5e, 5f, and 5g, a method 500 for interconnect error notification is provided that greatly simplifies and speeds up the process of correcting interconnect errors. As discussed below, the method 500 provides for the visual indication of ports that are associated with interconnect errors to assist a user or administrator in quickly and easily recognizing incorrectly interconnected ports and the switches including those ports so that the interconnect errors may be quickly and easily corrected. The method 500 begins at block 502 where a meshed Ethernet fabric configuration is received. In an embodiment, a user or administrator may provide the fabric manager 310 (e.g., using the management IHS 312) with a variety of meshed Ethernet fabric information including, for example, a distributed core name, a distributed core type (e.g., large, medium, or small), a distributed core description, an interlink over-subscription ratio, a number of port uplinks and/or downlinks required by the distributed core, a number of additional ports required for future expansion of the distributed core, an interlink configuration, protocol settings, an uplink configuration, a downlink configuration, and/or a variety of other meshed Ethernet fabric information known in the art.

Upon receiving the meshed Ethernet fabric configuration, the method 500 proceeds to block 504 where the fabric manager 310 determines a plurality of meshed Ethernet fabric details. In an embodiment, using the meshed Ethernet fabric configuration, the fabric manager 310 determines a number of spine switch IHSs and a number of leaf switch IHSs required for the meshed Ethernet fabric configuration, as well as an interconnect plan that details the interconnections between the spine switch IHSs and the leaf switch IHSs.

Referring now to FIGS. 5a, 5b, and 5c, the method 500 then proceeds to block 506 where interconnect instructions are provided. Using the plurality of meshed Ethernet fabric details determined at block 504, the fabric manager 310 outputs a graphic interconnect plan 600, illustrated in FIG. 5b, and a tabular interconnect plan 700, illustrated in FIG. 5c. While the graphical interconnect plan 600 and the tabular interconnect plan 700 are discussed below as being displayed on a display, the graphical interconnect plan 600 and the tabular interconnect plan 700 may also be output to a physical medium (e.g., printed) for use by a user or administrator in interconnecting the meshed Ethernet fabric 300.

FIG. 5b illustrates an embodiment of the management IHS 312 displaying on a display 312a a graphical interconnect plan 600 for a switch IHS in the meshed Ethernet fabric 300. In the illustrated embodiment, the graphical interconnect plan 600 is being displayed for a spine switch IHS and includes a switch IHS identifier 602 (e.g., “centralcore-Spine-1”), model information 604 (e.g., “Model=S4810”) about that spine switch IHS, a graphical interconnect plan legend 606 describing the meaning for the graphics used in the graphical interconnect plan 600, and a switch IHS graphical display 608 that includes identifiers for each port on the switch IHS along with a corresponding designation for the port on another switch in the meshed Ethernet fabric to which that port should be connected. For example, in the illustrated embodiment, the switch IHS graphical display 608 includes an identifier 610a for port 0 on the spine switch IHS (e.g., Spine-1) and a designation 610b that port 0 on another spine switch IHS (e.g., Spine 2) should be connected to that port (e.g., port 0 on Spine-1). Similarly, in the illustrated embodiment, the switch IHS graphical display 608 includes an identifier 612a for port 43 on the spine switch IHS (e.g., Spine-1) and a designation 612b that port 42 on a Leaf switch IHS (e.g., Leaf-10 S) should be connected to that port (e.g., port 43 on Spine-1). In addition, in the illustrated embodiment, the switch IHS graphical display 608 includes an indication 614 that port 56 on the spine switch IHS (e.g., Spine-1) is reserved for future use. As discussed above, a unique switch IHS graphical display may be output (e.g., on the display 312, printed, etc.) for each switch IHS in the meshed Ethernet fabric 300, and includes unique interconnect details for ports on that switch IHS.

FIG. 5c illustrates an embodiment of the management IHS 312 displaying on the display 312a a tabular interconnect plan 700 for a switch IHS in the meshed Ethernet fabric 300. In the illustrated embodiment, the tabular interconnect plan 700 is being displayed for a spine switch IHS (e.g., “centralcore-Spine-1”) and includes a switch IHS table 702 having a column 704 for each port on the switch IHS along with columns 706 and 708 that detail the port on another switch in the meshed Ethernet fabric to which the port in column 704 should be connected. For example, in the illustrated embodiment, the first illustrated row 710 in the switch IHS table 702 identifies that port 16 on centralcore-Spine-1 should be connected to port 41 on centralcore-Leaf-3-S. As discussed above, a unique switch IHS table may be output (e.g., on the display 312, printed, etc.) for each switch IHS in the meshed Ethernet fabric 300, and includes unique interconnect details for ports on that switch IHS.

The method 500 then proceeds to blocks 508 and 510 where a user sets up the networked system 200 and deploys the meshed Ethernet fabric 300. In an embodiment, setting up the networked system 200 may include, for example, racking the switch IHSs, interconnecting the switches (e.g., using interconnect cables) with each other and other devices in the networked system 200, assigning switch identities to each switch IHS (e.g., assigning chassis media access control (MAC) addresses, serial number, and/or service tags to each switch IHS), assigning management internet protocol (IP) addresses to each switch IHS, providing software images for each switch IHS, and/or a variety of other networked system setup operations known in the art.

Following deployment of the meshed Ethernet fabric 300, the method 500 then proceeds to block 512 where interconnect errors are detected. In an embodiment, the port interconnect reporting engine 414 on each switch IHS in the meshed Ethernet fabric 300 communicates through the communication engine 412 with the fabric manager 310 to report the interconnect status of each port 406 on its corresponding switch IHS. The fabric manager 310 then compares the reported interconnect status with the meshed Ethernet fabric details (e.g., the meshed Ethernet fabric details used to create the graphic interconnect plan 600 and the tabular interconnect plan 700) to determine one or more interconnect errors. For example, the fabric manager 310 may compare the reported interconnect status with the meshed Ethernet fabric details to determine a missing link interconnect error when the meshed Ethernet fabric details indicate that a port on a switch IHS should be connected to an interconnect, but the reported interconnect status indicates that that port is not connected to an interconnect. In another example, the fabric manager 310 may compare the reported interconnect status with the meshed Ethernet fabric details to determine a wiring mismatch interconnect error when the meshed Ethernet fabric details indicate that a first port on a first switch IHS is connected by an interconnect to a second port on a second switch, but the reported interconnect status indicates that that the first port should not be connected to the second port. While a few examples of interconnect errors have been provided, one of skill in the art will recognize that the reported interconnect status may be compared with the meshed Ethernet fabric details to determine a variety of interconnect errors while remaining within the scope of the present disclosure.

The method 500 then proceeds to block 514 where interconnect error information is provided. In an embodiment, the fabric manager 300 may output a missing link interconnect error table 800, illustrated in FIG. 5d, a wiring mismatch interconnect error table 900, illustrated in FIG. 5e, and a graphical interconnect error screen 1000, illustrated in FIG. 5f. While the missing link interconnect error table 800, the wiring mismatch interconnect error table 900, and the graphical interconnect error screen 1000 are discussed below as being displayed on a display, the missing link interconnect error table 800, the wiring mismatch interconnect error table 900, and the graphical interconnect error screen 1000 also be output to a physical medium (e.g., printed) for use by a user or administrator in correcting interconnect errors in the meshed Ethernet fabric 300.

FIG. 5d illustrates an embodiment of the management IHS 312 displaying on a display 312a a missing link interconnect error table 800 for a switch IHS in the meshed Ethernet fabric 300. In the illustrated embodiment, the missing link interconnect error table 800 is being displayed for a spine switch IHS (e.g., “Southcore-Spine-2”), and includes a column 802 that identifies ports that should be connected to another switch IHS in the meshed Ethernet fabric 300 but that are not (i.e., “missing link” ports), along with columns 804 and 806 that indicate the switch IHS and the port on that switch IHS to which the missing link port should be connected. For example, in the illustrated embodiment, the first illustrated row indicates that the TenGigabit Ethernet 0/8 port on the Southcore-Spine-2 switch IHS should be connected to the TenGigabitEthernet 0/4 port on the Southcore-Leaf-2 switch IHS, but is not connected to any switch IHS (e.g., no interconnect has been reported as being connected to the TenGigabit Ethernet 0/8 port on the Southcore-Spine-2 switch IHS.)

FIG. 5e illustrates an embodiment of the management IHS 312 displaying on a display 312a a wiring mismatch interconnect error table 900 for a switch IHS in the meshed Ethernet fabric 300. In the illustrated embodiment, the wiring mismatch interconnect error table 900 is being displayed for leaf switch IHSs (e.g., “Southcore-Leaf-1” and “Southcore-Leaf-2”), and includes a column 902 that identifies ports that are incorrectly connected to another switch IHS in the meshed Ethernet fabric 300 (i.e., “wiring mismatch” ports), along with columns 904 and 906 that indicate the switch IHS and the port on that switch IHS to which the wiring mismatch port should be connected, and columns 908 and 910 that indicate the switch IHS and the port on that switch IHS to which the wiring mismatch port has been detected as being connected to. For example, in the illustrated embodiment, the first illustrated row indicates that the TenGigabit Ethernet 0/4 port on the Southcore-Leaf-2 switch IHS should be connected to the TenGigabitEthernet 0/8 port on the Southcore-Spine-2 switch IHS, but is actually connected to the TenGigabit Ethernet 0/4 port on a switch IHS with an address of 00:01:d8:8b:15:89).

FIG. 5f illustrates an embodiment of the management IHS 312 displaying on a display 312a a graphical interconnect error screen 1000 for a switch IHS in the meshed Ethernet fabric 300. In the illustrated embodiment, the graphical interconnect error screen 1000 includes a multi-core network column 1002 that allows the user to select a switch that is included in one of a plurality of distributed cores/meshed Ethernet fabrics in a networked system. In the illustrated embodiment, a user has selected a spine switch IHS in one of the distributed cores/meshed Ethernet fabrics in the networked system, and the graphical interconnect error screen 1000 includes a switch IHS identifier 1004 (e.g., “Westcore-Spine-01”) for the selected spine switch IHS, model information (e.g., “Dell S4810”) about that spine switch IHS, and a graphical interconnect error screen legend 1006 describing the meaning for the graphics used in a switch port status graphic 1008. The switch port status graphic 1008 includes a graphic for each port on the selected spine switch IHS that indicates the interconnect status of that port. For example, in the illustrated embodiment, a plurality of graphics 1008a are provided for ports for which no interconnect errors were detected (e.g., “healthy” ports according to the graphical interconnect error screen legend 1006), while a graphic 1008b is provided for a port for which an interconnect error was detected (e.g., a “critical” ports according to the graphical interconnect error screen legend 1006). A switch IHS interconnect summary 1010 is provided that may include information related to the interconnect status of the ports on the switch IHS. For example, for the error port for which the interconnect error was detected, information about that interconnect error may be provided and may include the whether the error port is a missing link port or a wiring mismatch port, which port on which switch the error port is current connected to, which port on which switch the error port should be connected to, and/or a variety of other interconnect error information known in the art. The user may use multi-core network column 1002 to select any switch IHS that is included in any of the plurality of distributed cores/meshed Ethernet fabrics in the networked system to display a graphical interconnect error screen for that switch IHS. Furthermore, while not illustrated, the user may use the multi-core network column to select a distributed core/meshed Ethernet fabric (e.g., the “Westcore”) and have a topology for that distributed core/meshed Ethernet fabric graphically displayed (e.g., with a graphic for each switch IHS included in the distributed core/meshed Ethernet fabric) with indicators of the switch IHSs in the distributed core/meshed Ethernet fabric that include ports that are associated with interconnect errors. Thus, the user may use the graphical interconnect error screen 1000 to quickly find the switches associated with interconnect errors and the ports on those switches that are associated with interconnect errors.

The method 500 then proceeds to block 516 where interconnect errors are visually indicated using visual port indicators. In an embodiment, at block 516, the fabric manager 310 communicates with each switch IHS that includes a port for which an interconnect error was detected in block 512 to cause the visual port indicator for that port to visually indicate the interconnect error associated with that port. For example, the fabric manager 310 may communicate through the communication engine 412 with the visual port indicator control engine 416, and that communication will cause the visual port indicator control engine 416 to send signals to the visual port indicators 408 and/or 410 that are associated with the ports for which interconnect errors are detected, and those signals will cause the visual port indicators to provide visual indications of the interconnect error for those ports.

As discussed above, in some embodiments, the visual port indicator control engine 416 in the switch IHS 400 may include low-level diagnostic controls that provide for direct control of the visual port indicators 408 or 410 (e.g., direct control of the state of the LED(s) included in the visual port indicators). In such embodiments, at block 516 of the method 500, the fabric manager 310 may communicate with the visual port indicator control engine 416 to cause the visual port indicator control engine to directly control the visual port indicators 408 and/or 410 to provide the visual indication of interconnect errors associated with a port. For example, the visual port indicator control engine 416 may include an operating system in the switch IHS 400 that is controlled by the fabric manager 310 to drive port LEDs (the visual port indicators). As discussed above, the fabric manager 310 may be remotely connected to the switch IHS 400 (through a server IHS connected to the switch IHS through a network) and may remotely control the behavior of the visual port indicators.

As also discussed above, in some embodiments, the visual port indicator control engine 416 in the switch IHS 400 may not include the low-level diagnostic controls discussed above, and instead may be operable to control each visual port indicator 408 and 410 based on the data traffic received by their associated port 406. In such embodiments, at block 516 of the method 500, the fabric manager 310 may communicate with the switch IHS 400 to configure each port 406 on the switch IHS 400 with a separate access virtual local area network (VLAN) with IP interfaces (or configuring each port 406 on the switch IHS 400 as a separate layer-3 interface when such a feature is available), and then the fabric manager 310 may generate data traffic for the VLAN associated with a port for which an interconnect error was detected, and that data traffic will be forwarded by the switch IHS 400 to that port and result in the visual port indicator control engine 416 activating the visual port indicators 408 and/or 410 according to the received data traffic for the port in order to provide the visual indication of interconnect errors associated with that port.

As discussed above, the visual port indicators may be single color visual port indicators 408 or multi-color visual port indicators 410. The table below includes some examples of visual port indications that may be provided by visual port indicators to visually indicate the interconnect status of their associated ports. For example, visual indications instructions that are accessible by the fabric manager 310 may be associated with multi-color visual port indicators, single color visual port indicators, and each of the interconnect states in the table below. When the fabric manager 310 determines a port is associated with an interconnect error, the fabric manager 310 may determine the type of visual port indicator (e.g., single color or multi-color) associated with that port, and then use the type of visual port indicator and the interconnect state of its associated port to retrieve the appropriate visual indication instruction. The fabric manager 310 may then communicate that visual indication instruction to the visual port indicator control engine 416 in the switch IHS that includes that port to cause that visual port indicator to provide a visual indication of the interconnect error detected for its associated port.

| | Interconnect State | | |
|---|---|---|---|
| | Multi-color visual port | | |
| | indicator | Single color visual port | Unmanaged visual |
| | (e.g., Green status | indicator | port indicator |
| | LED and Amber status | (e.g., only Green | (e.g., only Green |
| | LED) | status LED) | activity LED) |
| Correct Interconnect | Solid Green | Solid Green | Normal no-traffic |
| | | | indication |
| Wiring Mismatch | Flashing Amber | Fast flashing Green | Normal fast-traffic |
| | | | indication |
| Missing Link | Solid Amber | Slow flashing Green | Normal no-link |
| | | | indication |
| Off/Unused | Unlit | Unlit | Normal no-link |
| | | | indication |

In one example, when direct control of the visual port indicators is available, the fabric manager 310 may operate with the visual port indicator control engine 416 to directly drive per-port visual port indicators (e.g., port LEDs) with unused, missing link, wiring mismatch, and correct interconnect states based on the interconnect errors detected at block 512. In another example, when direct control of the visual port indicators is not available, the fabric manager 310 may generate traffic (e.g., control frames) on a per-port basis such that unused and unlinked states are indicated by a unlit link-state LED indicator, mismatch states are indicated by a lit link-state LED indicator and a rapidly flashing traffic LED indicator, and correct interconnect state is indicated by a lit link-sate LED indicator and a mostly non-flashing traffic LED indicator (e.g., as per the unmanaged visual port indicator column above.)

FIG. 5g illustrates a networked system 1100 that includes a first switch IHS 1102 and a second switch 1104. While only a few of the ports on the first switch IHS 1102 and the second switch IHS 1104 are illustrated as connected together for clarity of discussion and illustration, as discussed and illustrated above, each of the ports on the first switch IHS 1102 and the second switch IHS 1104 may be connected to another switch IHS. The first switch IHS 1102 includes a port 1106 that is associated with a visual port indicator 1106a, a port 1108 that is associated with a visual port indicator 1108a, and a port 1110 that is associated with a visual port indicator 1110a; and the second switch IHS 1104 includes a port 1112 that is associated with a visual port indicator 1112a, and a port 1114 that is associated with a visual port indicator 1114a. In the illustrated example, the port 1106 on the first switch IHS 1102 is not connected to an interconnect cable, the port 1108 on the first switch IHS 1102 is connected through an interconnect cable 1116 to the port 1112 on the second switch IHS 1104, and the port 1110 on the first switch IHS 1102 is connected through an interconnect cable 1118 to the port 1114 on the second switch IHS 1104.

At block 512, the fabric manager 310 may determine that the port 1106 on the first switch IHS 1102 should be connected to an interconnect cable but is not (e.g., the port 1106 is a missing link port), and at block 516, the fabric manager 310 will then cause the visual port indicator 1106a to visually indicate the missing link error (e.g., by causing an LED in the visual port indicator to provide a solid amber color or a slow flashing green color per the table above.) At block 512, the fabric manager 310 may determine that the port 1108 on the first switch IHS 1102 is correctly connected through the interconnect cable 1116 to the port 1112 on the second switch IHS 1104, and at block 516, the fabric manager 310 will then cause the visual port indicators 1108a and 1112a to visually indicate the correct interconnect (e.g., by causing an LED in the visual port indicator to provide a solid green color per the table above.) At block 512, the fabric manager 310 may determine that the port 1110 on the first switch IHS 1102 is incorrectly connected through the interconnect cable 1118 to the port 1114 on the second switch IHS 1104 (e.g., the ports 1110 and 1114 are wiring mismatch ports), and at block 516, the fabric manager 310 will then cause the visual port indicators 1110a and 1114a to visually indicate the wiring mismatch interconnect error (e.g., by causing an LED in the visual port indicators to provide a flashing amber color or a fast flashing green color per the table above.) FIG. 5g along with FIG. 5h illustrate how, in some situations, a user may quickly fix the interconnect error by, for example, disconnecting the interconnect cable 1118 from the port 1110 on the first switch IHS 1102 and connecting that interconnect cable 1118 to the port 1106 on the first switch IHS 1102, and then seeing if the visual port indicators 1106a and 1114a provide the visual indication of a correct interconnect, as illustrated.

Thus, interconnect error notification systems and methods have been described that allow a user to quickly and easily determine the locations of interconnect errors in complicated networked systems. With the visual port indicators on the switch IHSs in a meshed Ethernet fabric providing visual indications, a user of administrator may quickly find the switches and their ports for which interconnect errors are associated, and correct those errors.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An interconnect error notification system, comprising:
a processor; and
a non-transitory memory coupled to the processor and including instructions that, when executed by the processor, cause the processor to provide a fabric manager that is operable to:
communicate with a first switch that is part of a fabric that includes a second switch, wherein the first switch include a plurality of ports that are each associated with a respective visual port indicator located on the first switch, and at least one of the plurality of ports on the first switch is connected by an interconnect to the second switch;
determine that a fabric interconnect error is associated with a first port of the plurality of ports on the first switch; and
communicate with the first switch to cause the respective visual port indicator that is associated with the first port and that is located on the first switch to visually indicate the fabric interconnect error.

2. The interconnect error notification system of claim 1, wherein the communicating with the first switch to cause the respective visual port indicator that is associated with the first port to visually indicate the fabric interconnect error includes directly controlling the respective visual port indicator using diagnostic controls provided by the first switch.

3. The interconnect error notification system of claim 1, wherein the communicating with the first switch to cause the respective visual port indicator that is associated with the first port to visually indicate the fabric interconnect error includes generating and sending traffic to the first port to cause the respective visual port indicator to provide the visual indication.

4. The interconnect error notification system of claim 3, wherein the communicating with the first switch to cause the respective visual port indicator that is associated with the first port to visually indicate the fabric interconnect error includes configuring the first port with a separate access virtual local area network (VLAN) and then generating and sending the traffic to that VLAN.

5. The interconnect error notification system of claim 1, wherein the fabric manager is further operable to:
determine that the respective visual port indicator that is associated with the first port is a single color visual port indicator;
retrieve a visual indication instruction that is associated with the fabric interconnect error and the single color visual port indicator; and
communicate the visual indication instruction to the first switch to cause the single color visual port indicator that is associated with the first port to visually indicate the fabric interconnect error.

6. The interconnect error notification system of claim 1, wherein the fabric manager is further operable to:
determine that the respective visual port indicator that is associated with the first port is a multi-color visual port indicator;
retrieve a visual indication instruction that is associated with the fabric interconnect error and the multi-color visual port indicator; and
communicate the visual indication instruction to the first switch to cause the multi-color visual port indicator that is associated with the first port to visually indicate the fabric interconnect error.

7. The cabling error notification system of claim 1, wherein the fabric interconnect error is determined in response to determining either that an interconnect connecting the first port to the second switch is connected to a wrong port, or that the first port is not connected to an interconnect.

8. An information handling system (IHS) network, comprising:
a fabric including:
a first switch including a plurality of first switch ports and a respective visual first switch port indicator associated with each of the plurality of first switch ports;
a second switch including a plurality of second switch ports and a respective visual second switch port indicator associated with each of the plurality of second switch ports; and
at least one interconnect connecting one of the plurality of first switch ports to one of the plurality of second switch ports; and
a fabric manager coupled to the fabric, wherein the fabric manager is operable to:
communicate with the first switch and the second switch;
determine that the first switch includes an error first switch port of the plurality of first switch ports that is that associated with a fabric interconnect error; and
communicate with the first switch to cause the respective visual first switch port indicator that is associated with the error first switch port and that is located on the first switch to visually indicate the fabric interconnect error.

9. The IHS network of claim 8, wherein the communicating with the first switch to cause the respective visual first switch port indicator that is associated with the error first switch port to visually indicate the fabric interconnect error includes directly controlling the respective visual first switch port indicator using diagnostic controls provided by the first switch.

10. The IHS network of claim 8, wherein the communicating with the first switch to cause the respective visual first switch port indicator that is associated with the error first switch port to visually indicate the fabric interconnect error includes generating and sending traffic to the error first switch port to cause the respective visual first switch port indicator to provide the visual indication.

11. The IHS network of claim 10, wherein the communicating with the first switch to cause the respective visual first switch port indicator that is associated with the error first switch port to visually indicate the fabric interconnect error includes configuring the error first switch port with a separate access virtual local area network (VLAN) and then generating and sending the traffic to that VLAN.

12. The IHS network of claim 8, wherein the fabric manager is further operable to:
determine that the respective visual first switch port indicator that is associated with the error first switch port is a single color visual port indicator;
retrieve a visual indication instruction that is associated with the fabric interconnect error and the single color visual port indicator; and
communicate the visual indication instruction to the first switch to cause the single color visual port indicator that is associated with the error first switch port to visually indicate the fabric interconnect error.

13. The IHS network of claim 8, wherein the fabric manager is further operable to:
determine that the respective visual first switch port indicator that is associated with the error first switch port is a multi-color visual port indicator;
retrieve a visual indication instruction that is associated with the fabric interconnect error and the multi-color visual port indicator; and
communicate the visual indication instruction to the first switch to cause the multi-color visual port indicator that is associated with the error first switch port to visually indicate the fabric interconnect error.

14. The IHS network of claim 8, wherein the fabric interconnect error is determined in response to determining either that the error first switch port should not be connected to one of the second switch ports on the second switch by the at least one interconnect, or that the error first switch port is not connected to the at least one interconnect.

15. A method for interconnect error notification, comprising:
communicating with a first switch that is part of a fabric that includes a second switch, wherein the first switch include a plurality of ports that are each associated with a respective visual port indicator located on the first switch, and at least one of the plurality of ports on the first switch is connected by an interconnect to the second switch;
determining that a fabric interconnect error is associated with a first port of the plurality of ports on the first switch; and
communicate with the first switch to cause the respective visual port indicator that is associated with the first port and that is located on the first switch to visually indicate the fabric interconnect error.

16. The method of claim 15, wherein the communicating with the first switch to cause the respective visual port indicator that is associated with the first port to visually indicate the fabric interconnect error includes directly controlling the respective visual port indicator using diagnostic controls provided by the first switch.

17. The method of claim 15, wherein the communicating with the first switch to cause the respective visual port indicator that is associated with the first port to visually indicate the fabric interconnect error includes generating and sending traffic to the first port to cause the respective visual port indicator to provide the visual indication.

18. The method of claim 15, further comprising:
determining that the respective visual port indicator that is associated with the first port is a single color visual port indicator;
retrieving a visual indication instruction that is associated with the fabric interconnect error and the single color visual port indicator; and
communicating the visual indication instruction to the first switch to cause the single color visual port indicator that is associated with the first port to visually indicate the fabric interconnect error.

19. The method of claim 15, further comprising:
determining that the respective visual port indicator that is associated with the first port is a multi-color visual port indicator;
retrieving a visual indication instruction that is associated with the fabric interconnect error and the multi-color visual port indicator; and
communicating the visual indication instruction to the first switch to cause the multi-color visual port indicator that is associated with the first port to visually indicate the fabric interconnect error.

20. The method of claim 15, wherein the fabric interconnect error is determined in response to determining either that an interconnect connecting the first port to the second switch is connected to a wrong port, or that the first port is not connected to an interconnect.
